(19) United States
(12) Patent Application Publication
(10) Pub. No.: US 2015/0013525 A1
(43) Pub. Date: Jan. 15, 2015

(54) Music User Interface Sensor

(71) Applicant: Tymm Twillman, San Francisco, CA (US)

(72) Inventor: Tymm Twillman, San Francisco, CA (US)

(73) Assignee: MISELU INC., San Francisco, CA (US)

(21) Appl. No.: 14/326,421

(22) Filed: Jul. 8, 2014

Related U.S. Application Data
(60) Provisional application No. 61/844,378, filed on Jul. 9, 2013.

(51) Int. Cl. G10G 3/04

(52) U.S. Cl. CPC G10G 3/04
USPC 84/462

(57) ABSTRACT

Embodiments generally relate to a music user interface sensor. In one embodiment, a method includes receiving an analog signal from a non-contact sensor of a music device. The method also includes determining a plurality of positions of a key of the music device based on the analog signal.

### CROSS REFERENCE TO RELATED APPLICATIONS

This application claims priority from U.S. Provisional Patent Application No. 61/844,378 entitled “Music User Interface Sensor,” filed Jul. 9, 2013, which is hereby incorporated by reference as if set forth in full in this application for all purposes.

### BACKGROUND

The creation of music is a popular activity enjoyed by many people. Various musical instrument devices and music applications enable a user to create music. Such devices and applications provide sounds that emulate the sounds of musical instruments. For example, a keyboard with piano keys when pressed may make piano sounds.

### SUMMARY

Embodiments generally relate to a music user interface sensor. In one embodiment, a method includes receiving an analog signal from a non-contact sensor of a music device. The method also includes determining a plurality of positions of a key of the music device based on the analog signal.

### BRIEF DESCRIPTION OF THE DRAWINGS

FIG. 1 is a block diagram of an example system, which may be used to implement the embodiments described herein.

FIG. 2 illustrates an example simplified flow diagram for controlling sound, according to some embodiments.

FIG. 3 illustrates an example simplified user interface that displays multiple musical instrument selections, according to some embodiments.

FIG. 4 is a schematic side view showing example keys of a piano keyboard, according to some embodiments.

FIG. 5 illustrates an example simplified flow diagram for detecting key positions using a non-contact sensor, according to some embodiments.

FIG. 6 illustrates an example simplified flow diagram for improving responsiveness of a piano keyboard, according to some embodiments.

FIG. 7 is a schematic side view showing a pop-up apparatus in an open state, according to some embodiments.

FIG. 8 is a schematic side view showing a pop-up apparatus in a more closed state than in FIG. 7, according to some embodiments.

FIG. 9 is a schematic side view showing an example portion of a pop-up assembly implemented as a keyboard apparatus in an open state, according to some embodiments.

FIG. 10 is a schematic side view showing an example portion of a pop-up assembly implemented as a keyboard apparatus in closed state, according to some embodiments.

FIG. 11 is a schematic top view of an example pop-up assembly implemented as a keyboard apparatus in a closed state, according to some embodiments.

FIG. 12 is a schematic perspective view of an example pop-up assembly implemented as a keyboard apparatus in an open state, according to some embodiments.

FIG. 13 is a schematic perspective view of an example pop-up assembly implemented as a keyboard apparatus in an open state, according to some embodiments.

FIG. 14 illustrates an example simplified flow diagram for providing a pop-up apparatus, according to some embodiments.

### DETAILED DESCRIPTION

Embodiments generally relate to a music user interface sensor. In one embodiment, a method includes providing a non-contact sensor in a music device, where the music device includes at least one key. The method also includes generating an analog signal based on continuous movement of the at least one key. The method also includes determining a plurality of positions of the key based on the analog signal.

Embodiments described herein also enable a user to control sound and play a musical instrument. In various embodiments, a processor provides a user interface to a user, where the user interface displays multiple musical instrument selections. When the processor receives a particular musical instrument selection from the user, the processor controls the sound type based on the musical instrument selection and controls the responsiveness based on the musical instrument selection.

As a result, the user has the experience of producing music with more precision and authenticity to particular musical instruments. Embodiments provide the user with a sense of creativity by providing a music user interface having simple and intuitive musical instrument selections.

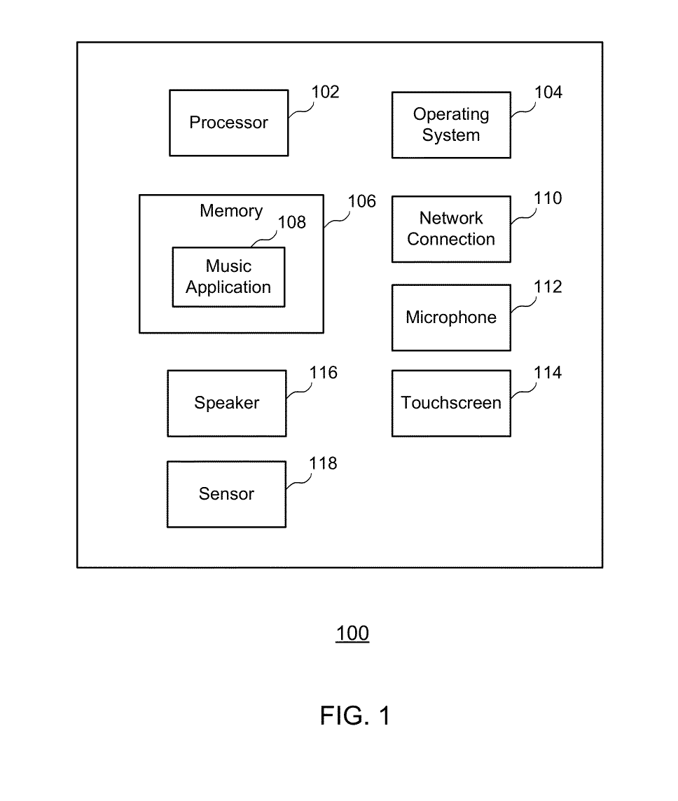

FIG. 1 is a block diagram of an example system 100, which may be used to implement the embodiments described herein. In some embodiments, computer system 100 may include a processor 102, an operating system 104, a memory 106, a music application 108, a network connection 110, a microphone 112, a touchscreen 114, a speaker 116, and a sensor 118. For ease of illustration, the blocks shown in FIG. 1 may each represent multiple units. In other embodiments, system 100 may not have all of the components shown and/or may have other elements including other types of elements instead of, or in addition to, those shown herein.

Music application 108 may be stored on memory 106 or on any other suitable storage location or computer-readable medium. Music application 108 provides instructions that enable processor 102 to perform the functions described herein. In various embodiments, music application 108 may run on any electronic device including smart phones, tablets, computers, etc.

In various embodiments, touchscreen 114 may include any suitable interactive display surface or electronic visual display that can detect the presence and location of a touch within the display area. Touchscreen 114 may support touching the display with a finger or hand, or any suitable passive object, such as a stylus. Any suitable display technology (e.g., liquid crystal display (LCD), light emitting diode (LED), etc.) can be employed in touchscreen 114. In addition, touchscreen 114 in particular embodiments may utilize any type of touch detecting technology (e.g., resistive, surface acoustic wave (SAW) technology that uses ultrasonic waves that pass over the touchscreen panel, a capacitive touchscreen with an insulator, such as glass, coated with a transparent conductor, such as indium tin oxide (ITO), surface capacitance, mutual capacitance, self-capacitance, projected capacitive touch (PCT) technology, infrared touchscreen technology, optical imaging, dispersive signal technology, acoustic pulse recognition, etc.).

In various embodiments, processor 102 may be any suitable processor or controller (e.g., a central processing unit (CPU), a general-purpose microprocessor, a microcontroller, a microprocessor, etc.). Further, operating system 104 may be any suitable operating system (OS), or mobile OS/platform, and may be utilized to manage operation of processor 102, as well as execution of various application software. Examples of operating systems include Android from Google, iPhone OS (iOS), Berkeley software distribution (BSD), Linux, Mac OS X, Microsoft Windows, and UNIX.

In various embodiments, memory 106 may be used for instruction and/or data memory, as well as to store music and/or video files created on or downloaded to system 100. Memory 106 may be implemented in one or more of any number of suitable types of memory (e.g., static random access memory (SRAM), dynamic RAM (DRAM), electrically erasable programmable read-only memory (EEPROM), etc.). Memory 106 may also include or be combined with removable memory, such as memory sticks (e.g., using flash memory), storage discs (e.g., compact discs, digital video discs (DVDs), Blu-ray discs, etc.), and the like. Interfaces to memory 106 for such removable memory may include a universal serial bus (USB), and may be implemented through a separate connection and/or via network connection 110.

In various embodiments, network connection 110 may be used to connect other devices and/or instruments to system 100. For example, network connection 110 can be used for wireless connectivity (e.g., Wi-Fi, Bluetooth, etc.) to the Internet (e.g., navigable via touchscreen 114), or to another device. Network connection 110 may represent various types of connection ports to accommodate corresponding devices or types of connections. For example, additional speakers (e.g., Jawbone wireless speakers, or directly connected speakers) can be added via network connection 110. Also, headphones via the headphone jack can also be added directly, or via wireless interface. Network connection 110 can also include a USB interface to connect with any USB-based device.

In various embodiments, network connection 110 may also allow for connection to the Internet to enable processor 102 to send and receive music over the Internet. As described in more detail below, in some embodiments, processor 102 may generate various instrument sounds coupled together to provide music over a common stream via network connection 110.

In various embodiments, speaker 116 may be used to play sounds and melodies generated by processor 102. Speaker 116 may also be supplemented with additional external speakers connected via network connection 110, or multiplexed with such external speakers or headphones.

In some embodiments, sensor 118 may be a non-contact sensor. In some embodiments, sensor 118 may be an optical non-contact sensor. In some embodiments, sensor 118 may be a near-infrared optical non-contact sensor. As described in more detail below, in various embodiments, sensor 118 enables other embodiments described herein.

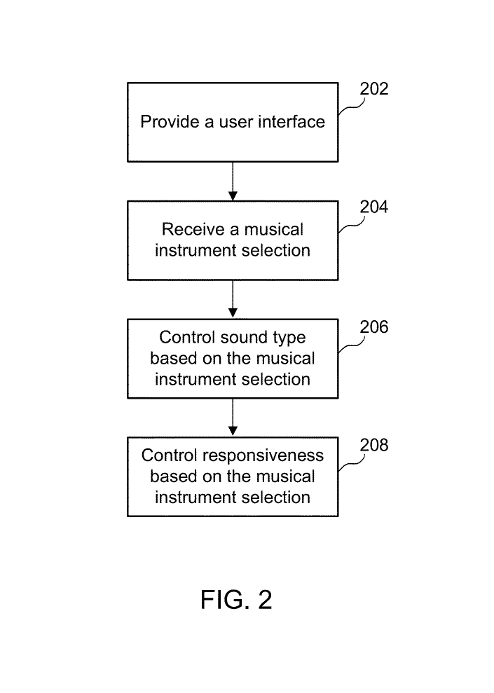

FIG. 2 illustrates an example simplified flow diagram for controlling sound, according to some embodiments. As described in more detail below, various embodiments enable a single user selection to result in both the sound type and the responsiveness of the keys to mimic various physical musical instruments. Referring to both FIGS. 1 and 2, a method is initiated in block 202 where processor 102 provides a user interface to a user, where the user interface displays multiple musical instrument selections.

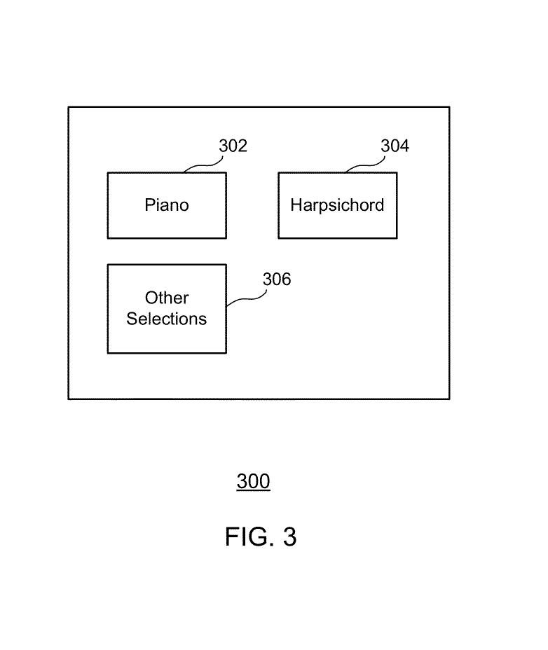

FIG. 3 illustrates an example simplified user interface 300 that displays multiple musical instrument selections, according to some embodiments. As shown, user interface 300 includes example musical instrument selections 302, 304, and 306.

A single selection of musical instrument selection 302 provides the user with a combination of a piano sound and piano responsiveness. Similarly, a single selection of musical instrument selection 304 provides the user with a combination of a harpsichord sound and harpsichord responsiveness. As indicated above, these are example musical instrument selections, and others are possible depending on the particular embodiment.

Referring again to FIG. 2, in block 204, processor 102 receives a musical instrument selection from the user. For example, after the user selects musical instrument selection 302, processor 102 receives that musical instrument selection (e.g., piano).

In block 206, processor 102 controls sound type based on the musical instrument selection. For example, if the user selects musical instrument selection 302, processor 102 controls the sound of the keyboard such that the sound mimics a piano. If the user selects musical instrument selection 304, processor 102 controls the sound of the keyboard such that the sound mimics a harpsichord.

In various embodiments, the sound type is a predetermined sound type associated with any particular type of musical instrument (e.g., piano, harpsichord, etc.) or associated with any other sound (e.g., synthesized sounds). Based on the sound type processor 102 may access a sound input the form of sound waves, in the form of an audio file, or in any suitable form, and from any suitable storage location, device, network, etc. In various embodiments, an audio file may be a musical instrument digital interface (MIDI) file, or an audio file in any other suitable audio format.

In some embodiments, processor 102 may receive the sound input via any suitable music device such as a musical keyboard. The musical keyboard may be a device that connects to network connection 110. The musical keyboard may also be a local application that uses touchscreen 114 to display a musical keyboard, notation, etc.

In block 208, processor 102 controls responsiveness based on the musical instrument selection. In some embodiments, if the user selects musical instrument selection 302, processor 102 controls the responsiveness of the keyboard such that keys when pressed mimic the behavior of a piano. For example, when the user presses a given key, processor 102 may cause a corresponding piano sound to begin before the key reaches the bottom of its range of motion. This aspect may be referred to as a trigger point, and is described in more detail below. Trigger points and other aspects of responsive may vary depending on the particular embodiment. For example, the volume of the piano sound may vary depending on the velocity of the moving key.

In some embodiments, if the user selects musical instrument selection 304, processor 102 controls the responsiveness of the keyboard such that the keys when pressed mimic the behavior of harpsichord. For example, when the user presses a given key, processor 102 may cause a corresponding harpsichord sound to begin when the key reaches the bottom of its range of motion. Also, the volume of the harpsichord sound may remain the same regardless of the velocity of the moving key.

In various embodiments, processor 102 may use any suitable algorithm to control the responsiveness of a piano key when the user depresses the key. For example, in some embodiments, processor 102 may use an algorithm that interacts with a sensor that senses the positions of the keys.

In various embodiments, the responsiveness of the keyboard may include various aspects. For example, responsiveness of the keyboard (e.g., key responses) may include a single triggering point, multiple trigger points, velocity, resistance, etc. In various embodiments, a combination of these and other aspects may correspond to behaviors and various musical instruments, which may include keyboard instruments, non-keyboard musical instruments (e.g., string, woodwind, brass, percussion, etc.), as well as synthesizer instruments.

As indicated above, in some embodiments, sensor 118 of FIG. 1 is non-contact sensor (e.g., an optical non-contact sensor) that provides varying levels or degrees of responsiveness of a piano keyboard when keys are depressed.

In various embodiments, because a non-contact sensor is used, the sensor signal generated from a key press of a corresponding key is a continuous analogue variable (rather than a discreet variable). In other words, the information determined from the movement of a given key is continuous.

In various embodiments, sensor 118 may include multiple emitters and multiple sensors such that an emitter-sensor pair may correspond to and interact with a different key to determine the position of the key. In some embodiments, the amount of occlusion (e.g., signal strength) of a given sensor varies as the corresponding key moves past (e.g., toward and away) from the sensor. In some embodiments, a given occlusion may correspond to a particular key position. As such, processor 102 may ascertain the position of a given key based on the occlusion of the corresponding sensor. Furthermore, processor 102 may assign a trigger point at which the position of the key triggers a sound.

In various embodiments, sensor 118 is a non-contact sensor that utilizes electromagnetic interference to precisely determine the position of each key. Sensor 118 detects key movement when a given key moves past its corresponding sensor.

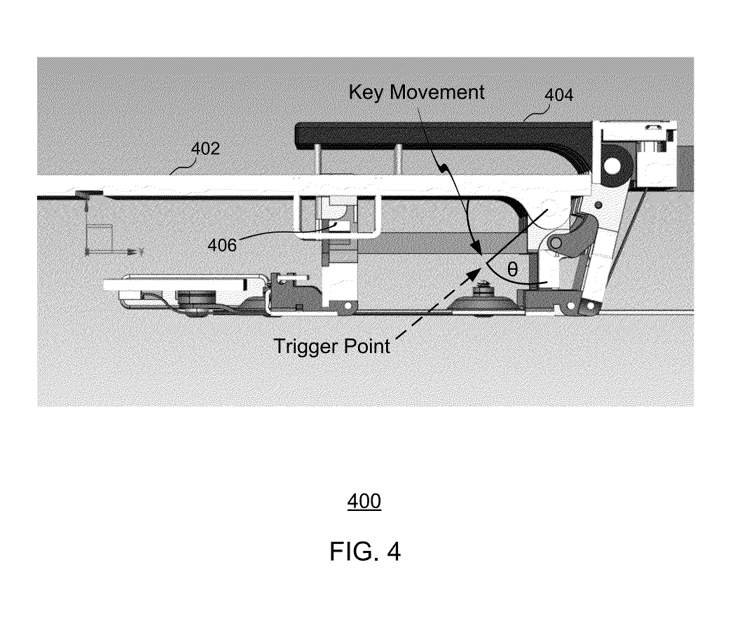

FIG. 4 is a schematic side view showing an example assembly 400 that includes keys of a piano keyboard, according to some embodiments. FIG. 4 shows a white key 402 and a black key 404. As shown, white key 402 moves or traverses (rotates along) a range of motion when the user presses the key (e.g., downward on the left portion of white key 402). As described in more detail below, when white key 402 reaches a trigger point at a predetermined threshold angle theta, processor 102 causes a sound to be generated in response to white key 402 reaching the trigger point. As described in more detail below, different predetermined threshold angles correspond to different trigger points. These implementations also apply to the black key 404, as well as to the other keys (not shown) of the keyboard.

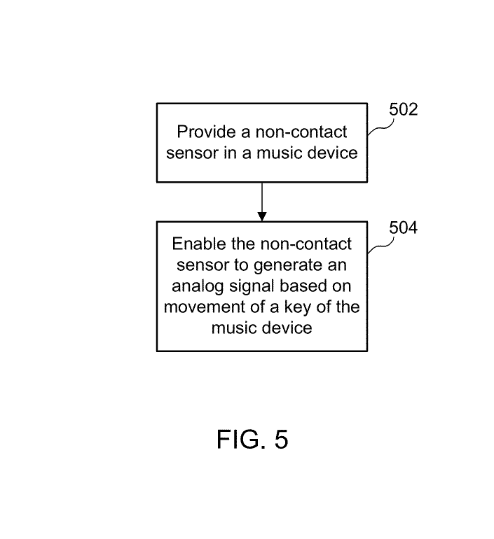

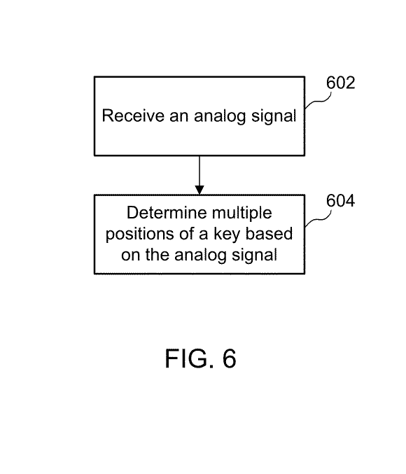

In some implementations, mechanism 400 includes a sensor 406 that detects the position of key 402. In various implementations, sensor 406 may be located in different locations in mechanism 400, depending on the particular implementation. Example implementations of sensor 406 are described in more detail below in connection with FIGS. 5 and 6.

In some embodiments, a given key traverses (rotates through) angle thresholds theta 1 and theta 2 (not shown), where each angle corresponds to a different musical instrument. For example, theta 1 may correspond to a piano, and theta 2 may correspond to a harpsichord. Each angle threshold theta 1 and theta 2 may correspond to a different trigger point. In some implementations, the key may travel linearly instead of rotationally, where distance thresholds may substitute angle thresholds.

In some embodiments, processor 102 assigns a different position of triggering (trigger point) to different analog representations of the positions of the keys.

For example, referring again to FIG. 3, if a piano 302 is selected, when a given key travels downward and reaches theta 1 (piano), processor 102 may cause a corresponding piano sound to begin even before the key reaches the bottom of its range of motion. If a harpsichord is selected, theta 2 may be at 0 degrees. As such, when a given key travels downward and reaches theta 2 (harpsichord), processor 102 may cause a corresponding harpsichord sound to begin when the key reaches the bottom of its range of motion.

As indicated above, other musical instrument selections are possible. For example, in one embodiment, a musical instrument selection may an organ, where theta may substantially be at 45 degrees. As such, the trigger point may be half way down such that an organ sound is generated when a key is pressed half way down.

In some embodiments, processor 102 may enable the user to have more control over responsiveness by enabling the user to select a particular trigger point. In other words, in some embodiments, processor 102 may enable a user to modify the feel of the keyboard such that the responsiveness is not tied to a particular musical instrument. For example, processor 102 may enable the user to modify the responsiveness such that the user can play lighter and still produce sound. In some embodiments, processor 102 may enable some keys to have a different responsiveness than other keys. For example, if the user plays more lightly with the left hand compared to the right hand (e.g., naturally or due to a physical limitation, etc.), processor 102 may enable the user to modify the responsiveness to be higher for the left hand. As such, the user may play more lightly with the left hand and more heavily with the right hand and still produce a relatively even sound across the keyboard.

In some embodiments, varying resistance may be achieved using electromagnetic technologies. For example, in some embodiments, magnets and spacers may be used to provide resistance when keys are pressed. In some embodiments, the position of magnets and spacers may be changed (e.g., lowered/raised) in order to modify the resistance of keys. In some embodiments, the magnets may be held in place by clips, with the spacers between magnets. In some embodiments, springs may be used to provide resistance, and different spring tensions may be used to modify the resistance of the springs.

In various embodiments, a method includes providing a non-contact sensor in a music device, where the music device includes at least one key. The method also includes generating an analog signal based on continuous movement of the at least one key. The method also includes determining a plurality of positions of the key based on the analog signal.

FIG. 5 illustrates an example simplified flow diagram for detecting key positions using a non-contact sensor, according to some embodiments. Referring to both FIGS. 1, 4, and 5, a method is initiated in block 502 a non-contact sensor in a music device is provided. Specifically, non-contact sensor for each key of the piano keyboard is provided. For example, in various implementations, sensor 406 of FIG. 4 is such a non-contact sensor. In various implementations, the non-contact sensor functions to detect the position of a key such as key 402 of FIG. 4.

While some implementations are described herein in the context of a non-contact sensor for a single key of the music device, these implementations and others apply to multiple non-contact sensors for each and all of the keys of the piano keyboard.

In block 504, processor 102 enables the non-contact sensor to generate an analog signal based on the movement of a key of the music device. As described in more detail below, the analog signal is based on continuous movement of the key of the music device. Implementations enable system 102 to determine multiple locations of the key of the music device based on the analog signal.

FIG. 6 illustrates an example simplified flow diagram for improving responsiveness of a piano keyboard, according to some embodiments. Referring to both FIGS. 1 and 6, a method is initiated in block 602 processor 102 receives an analog signal from the non-contact sensor of the music device. In various implementations, the non-contact sensor is a photo sensor. As such, implementations described herein provide photo/optical sensing for keyboard actuation.

In block 604, processor 102 determines multiple positions of a key of the music device based on the analog signal. In various implementations, the analog signal is based on movement of the key of the music device. In various implementations, the analog signal is based on continuous movement of the key of the music device. As described in more detail below, implementations determine absolute positioning information for each key (e.g., precise key height).

In various implementations, processor 102 may detect which keys are pressed using a keyboard matrix circuit having rows and columns of wires that cross/connect. For example, in some implementations, if the keyboard has 24 keys representing black and white keys across 2 octaves, the system could have 12 rows (e.g., one row per key) and 2 columns (e.g., one column per octave). As such, there could be (12×2) 24 crossings/connections for 2 full octaves of notes, or 24 notes. The particular number of rows and columns may vary, and will depend on the particular implementation.

In various implementations, processor 102 scans the keyboard in rows and columns. In particular, processor 102 scans these crossings to determine which key or keys are pressed. Each connection corresponds to a unique key, which in turn corresponds to a unique note.

In various implementations, processor 102 turns on one row at a time, and reads values from each column in series. Processor 102 detects when there is a connection across a row and a column, or connections across row and multiple columns, or connections across different combinations of rows and columns.

In various implementations, processor 102 can read a switch, resistor, or other analog input such as the non-contact sensor in order to determine if there is a connection and processor 102 can determine which key is activated. In some implementations, each key is attached to a (structural) wire. In some implementations, the wire itself is the Z stop for the key, not the key itself.

As indicated above, processor 102 determines multiple positions of a given key based on the analog signal. In various implementations, the analog signal is based on continuous movement of the key. In some implementations, a structure addition on the base (bottom or side) of the key acts as the reflector. In various implementations, an emitter (e.g., LED) is adjacent to the non-contact sensor (e.g., photo transistor). The emitter transmits a light that reflects on the reflector, and the non-contact sensor receives the light and provides analog reading for determination of precise key height. In some implementations, the light may reflect off of a wire attached to the bottom surface of the key. Processor 102 determines the position of the key based on the amount of light detected by the non-contact sensor, which depends on the position of the key. In various implementations, the amount of light detected corresponds to a position of the key.

In various implementations, processor 102 collects all data within 1 millisecond. This time frame may depend on other parameters. In some implementations, because waiting for the non-contact sensor to output values takes some time, multiple non-contact sensor and/or emitters may be used in parallel. Multiple scans are made in short succession within the time period it takes to read one non-contact sensor. In various implementations, each point might not have the same amount of time between the light scan and where the measurement is made.

In some scenarios, if the emitter (e.g., LED) has been on a little longer, a higher reading would be expected. In some implementations, non-contact sensors that are scanned last may be compensated in software (e.g., in calibration). In some implementations, the response curve of the non-contact sensor is a step-like progression. In some implementations, processor 102 may measure a first key at the low point without a correction factor. In some implementations, processor 102 may measure a second key at a medium point with small correction factor. In some implementations, processor 102 may measure a third key at higher point with a higher correction factor, etc.

In some scenarios, if some emitters face one another, they could cause interference. In some implementations, one or more sets of emitters may be parallelized such that they are not facing one another in order for them to not interfere. In some implementations, processor 102 may perform the scanning of parallel non-contact sensors in a non-ordered fashion in order to minimize constructive interference between signal and non-contact sensor. In some implementations, processor 102 turns on the non-contact sensor before scanning. This more quickly parallelizes the sensor readings.

In some implementations, the non-contact sensor takes readings of points on curve (e.g., the output is in transition when readings are taken), and the non-contact sensor need not take readings at a final value, even though output values are in transition. In various implementations, the final value can be calculated based on the current value and elapsed time since the sending emitter was energized.

In some implementations, the brightness of the sending signal from the emitter may be increased in order to allow for a shortening of the period that the emitter is on. A shorter period will result in less of an opportunity for other electromagnetic interference to confuse signal.

In some implementations, the non-contact sensor is an infrared (IR) photo sensor. Using IR sensors increases the sampling rate when scanning keys, which increases and improves the responsiveness of the keyboard. In various implementations, the IR sensors are calibrated in order to reduce any variability in responsiveness. Such calibration may also take into account temperature sensitivities of the IR photo sensors.

In some implementations, processor 102 performs the scanning at a predetermined time relative to the emitter sending a signal and the non-contact sensor receiving the signal. As such, the triggering of the scanning is set such that the timing for each step of each reading is bounded. In some implementations, processor 102 measures the non-contact sensor during the sensor response at a predetermined time period (e.g., consistent delta) from when the emitter emits light. For example, a given emitter (e.g., LED) may be turned on for a small period of time. The non-contact sensor is then turn on a predetermined time period from when the emitter was turned on. The scanning may then occur a predetermined time period from when the non-contact sensor was turned on. This will improve the overall response time.

In some implementations, the non-contact sensor may be used as an amplifier, where the non-contact sensor receives a small amount of energy (e.g., photons) and outputs a signal (e.g., scattered electrons). The amplification of the flow of electrons is triggered by photons hitting the non-contact sensor.

In various implementations, multiple non-contact sensors read in parallel, and based on a single emission of light at a known time. In various implementations, processor 102 calibrates the sensor response. In some implementations, even with a multiple keys being pressed at once and with any given lag in reading the non-contact sensors, processor 102 may apply a software offset based on the time lags.

Embodiments described herein enable a user to enjoy a music playing experience that is relatively close to that of playing a standard size musical instrument. Embodiments provide a music device that is not only of reduced size while in a playable configuration, but also readily reconfigurable into an extremely compact, “collapsed” form when being transported or stored.

In various embodiments, an apparatus includes a first four-bar mechanism (e.g., a four-bar parallelogram linkage), operably connected to a first user interface, where the first four-bar mechanism enables the first user interface to be positioned in a first plane. The apparatus also includes a second four-bar mechanism (e.g., another four-bar parallelogram linkage) operably connected to a second user interface, where the second four-bar mechanism enables the second user interface to be positioned in a second plane. The apparatus also includes a third four-bar mechanism (e.g., a four-bar convex quadrilateral linkage) operably connected to the first and second four-bar mechanisms, where the third four-bar mechanism synchronizes movement of the first and second four-bar mechanisms.

As described in more detail below, in various embodiments, the apparatus includes a base that functions as a common bar in each of the first, second, and third four-bar mechanisms. Also, the first and third four-bar mechanisms share two common bars, one of which is the base, and the second and third four-bar mechanisms share two common bars, one of which is also the base.

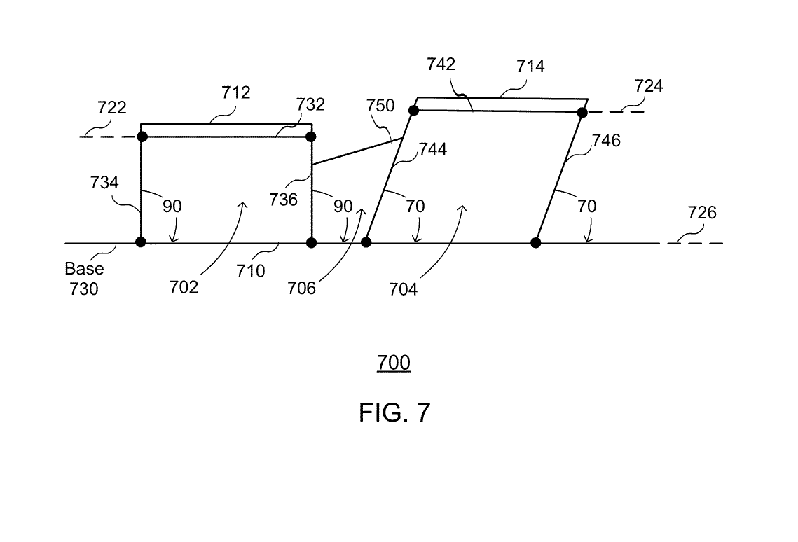

FIG. 7 is a schematic side view showing a pop-up apparatus 700 in an open state, according to some embodiments. As shown, in some embodiments, pop-up apparatus 700 includes three four-bar-mechanisms 702, 704, and 706. As shown, two of the four-bar-mechanisms 702 and 704 are four-bar parallelogram linkages, and one of the four-bar-mechanism 706 is a four-bar convex quadrilateral linkage.

In various embodiments, four-bar mechanism 702 is operably connected to a user interface 712, where four-bar mechanism 702 enables user interface 712 to be positioned in a plane 722. Furthermore, in various embodiments, four-bar mechanism 704 is operably connected to a user interface 714, where four-bar mechanism 704 enables user interface 714 to be positioned in a plane 724. As shown, plane 722 is different from plane 724, and both plans 722 and 724 are different from a plane 726, which is the plane of base 730.

Furthermore, in various embodiments, four-bar mechanism 706 is operably connected to four-bar mechanisms 702 and 704. As described in more detail below in connection with FIG. 2, four-bar mechanism 706 synchronizes movement of four-bar mechanisms 702 and 704.

In various embodiments, pop-up apparatus 700 includes a base 730 that not only functions a support base for pop-up apparatus 700 but also functions as a common bar in each of the first, second, and third four-bar mechanisms. As such, base 730 may also be referred to as base bar 730 or bar 730.

Four-bar mechanism 702 includes base bar 730, bar 732, bar 734, and bar 736. As shown, bar 732 is parallel to base bar 730, and bars 734 and 736 are parallel to each other. Four-bar mechanism 704 includes base bar 730, bar 742, bar 744, and bar 746. As shown, bar 742 is parallel to base bar 730, and bars 744 and 746 are parallel to each other. Four-bar mechanism 706 includes base bar 730, bar 736, bar 744, and a bar 750.

As shown, four-bar mechanisms 702 and 706 share two common bars—base bar 730 and bar 736. Four-bar mechanisms 704 and 706 share two common bars—base bar 730 and bar 744. As indicated above, all three four-bar mechanisms 702, 704, and 706 share base bar 730.

In various embodiments, the respective four bars of each of four-bar mechanisms 702, 704, and 706 are connected in a loop by four joints or pivot points (shown as solid circles). The bars may also be referred to as links. In various embodiments, the joints of each of four-bar mechanisms 702, 704, and 706 are configured to move all links relative to base bar 730, such that four-bar mechanisms 702, 704, and 706 function as rocker four-bar linkages. In other words bars 734, 736, 744, and 746 rotate around their respective joints that connect to base bar 730. As described in more detail below, the joints of four-bar mechanisms 702 and 706 are configured such that bars 732 and 742 move in parallel planes relative to base bar 730.

As described in more detail below, bar 750 of four-bar mechanism 706 connects bars 736 and 744. As such, bar 750 synchronizes movement of four-bar mechanisms 702 and 704, via bars 736 and 744.

In various embodiments, bar 732 lies substantially exactly in plane 722, and the bottom of user interface 712 lies substantially exactly in plane 722. The exact location of plane 722 relative to bar 732 and relative to the bottom of user interface 712 may vary, depending on the particular embodiment. Similarly, in various embodiments, bar 742 lies substantially exactly in plane 724, and the bottom of user interface 714 lies substantially exactly in plane 724. The exact location of plane 724 relative to bar 742 and relative to the bottom of user interface 714 may vary, depending on the particular embodiment.

FIG. 7 shows that pop-up apparatus 700 is in an open state, where user interfaces 712 and 714 are popped up, where user interface 712 is at a predetermined distance from base plane 730, and where user interface 714 is at a predetermined distance from base plane 730. The distance between user interface 712 and base plane 730 may vary depending on the particular implementation. Also, the distance between user interface 714 and base plane 730 may vary depending on the particular implementation.

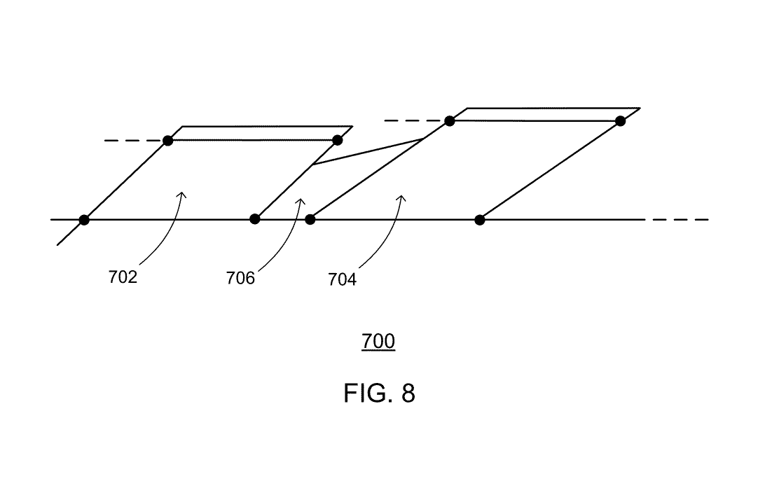

FIG. 8 is a schematic side view showing pop-up apparatus 700 in a more closed state than in FIG. 7, according to some embodiments. FIGS. 7 and 8 both illustrate spatial relationships between four-bar mechanisms 702, 704, and 706, where FIG. 7 shows pop-up apparatus 700 in an open state, and FIG. 8 shows pop-up apparatus 700 in a more closed state.

As shown in FIG. 8, as pop-up apparatus 700 approaches a closed state, bars 732 and 742 approach base bar 730. Also, planes 722 and 724 approach base plane 726. Also, the angle between bar 734 and base bar 730 and the angle between bar 736 and base bar 730 approach 0 degrees during the transition from the open state to the closed state. In some embodiments, these angles are both 90 degrees in the open state. In the open state, these angles may be other than 90 degrees depending on the particular embodiment.

Similarly, the angle between bar 744 and base bar 730 and the angle between bar 746 and base bar 730 approach 0 degrees during the transition from the open state to the closed state. In some embodiments, these angles are both 70 degrees in the open state. In the open state, these angles may be other than 70 degrees depending on the particular embodiment.

In the closed state, bars 732 and 742 are in line with base bar 730. Also, planes 722 and 724 are in line with base plane 726. For ease of illustration, FIG. 8 shows pop-up apparatus 700 in a state that is more closed than the open state, yet not in a fully closed state. This enables the components of four-bar mechanisms 702, 704, and 706 to be more clearly illustrated during the transition from the open state to closed state.

As indicated above, four-bar mechanism 706 synchronizes movement of four-bar mechanisms 702 and 704. Referring to both FIGS. 7 and 8, bar 750 connects bars 736 and 744. Accordingly, bar 750 connects four-bar mechanisms 702 and 706. As a result, when four-bar mechanism 702 transitions from the open state to the closed state, four-bar mechanism 704 also transitions from the open state to the closed state.

For ease of illustration, some embodiments are described herein in the context of pop-up apparatus 700 transitioning from the open state to the closed state. These same embodiments also apply in the context of pop-up apparatus 700 transitioning from the closed state to the open state, yet in reverse.

In various embodiments, four-bar mechanism 706 enables four-bar mechanisms 702 and 704 to reach the open state at substantially the same time, and to reach the closed state at substantially the same time. In some embodiments, this is achieved by four-bar mechanism 706 causing four-bar mechanism 704 to transition from the open state to the closed state, and vice versa, faster than four-bar mechanism 702. In other words, in various embodiments, whether pop-up apparatus 700 is transitioning from the open to the closed state, or vice versa, bar 742 travels faster than bar 732.

In various implementations, the rate at which four-bar mechanism 704 transitions from the open state to the closed state compared to the rate at which four-bar mechanism 702 transitions from the open state to the closed state, and vice versa, is based on where the ends of bar 750 are connected to respective bars 736 and 744. As shown, the ends of bar 750 are connected in somewhere in the middle portions of respective bars 736 and 744. The particular connection points will depend on the particular embodiment. Furthermore, the particular position or slope of bar 750 relative to base bar 730 will depend on the particular embodiment. In various embodiments, a combination of one or more of the angles of four-bar mechanism 706, the connection point locations, and/or the slope of bar 750 relative to base bar 730 determine the relative rates at which four-bar mechanisms 702 and 704 transition from the open state to the closed state, and vice versa.

As indicated above, four-bar mechanisms 702 and 704 may each be operably connected to one or more user interfaces. As described in more detail below, such user interfaces may include, for example, black and white keys of a piano keyboard. In some embodiments, user interfaces may include sound controls (e.g., knobs, sliders, buttons, capacitive touch strips, etc.). In some embodiments, user interfaces may connect directly to four-bar mechanisms 702 and 704 or may couple to a given four-bar mechanism 702 or 704 via an intermediary element such as a rack, which couples to the given four-bar mechanism 702 or 704.

In some embodiments, a rack may be coupled to a four-bar mechanism such as four-bar mechanism 704, where the rack is configured to hold/support objects. In some embodiments, the rack may be configured to hold an object that is controlled or viewable by a user. For example, the rack may be configured to hold an object such a user interface device (e.g., a tablet computer). In various embodiments, base 720 of pop-up apparatus 700 may be configured to function as a protective cover for an electronic device when pop-up apparatus 700 is in a closed stated. The rack may be configured to hold other objects as well, such as sheet music.

As indicated above, four-bar mechanisms 702 and 704 may support various types of user interfaces, such as black and white keys of a piano keyboard. As described in more detail below, for example, four-bar mechanism 702 may support white keys of a piano keyboard, and four-bar mechanism 704 may support black keys of the piano keyboard.

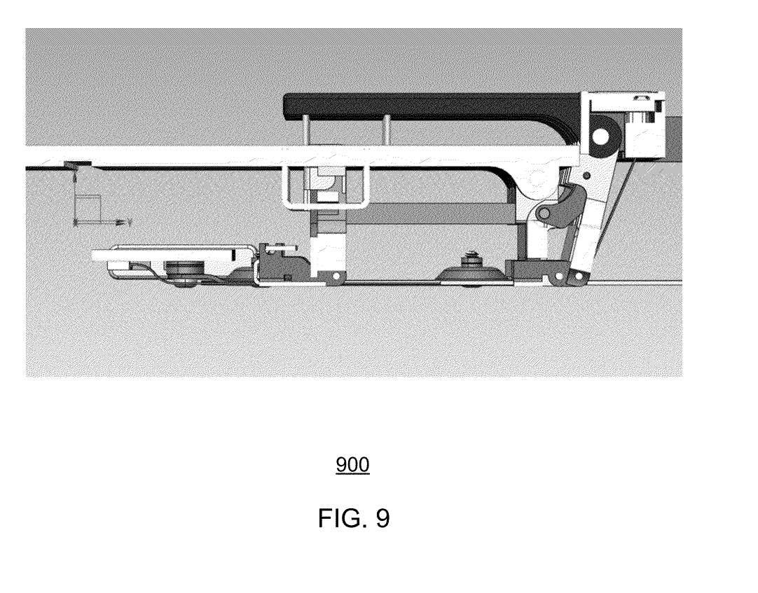

FIG. 9 is a schematic side view showing an example portion of a pop-up assembly 900 implemented as a keyboard apparatus in an open state, according to some embodiments. As shown, four-bar mechanism 702 may support white keys of a piano keyboard, and four-bar mechanism 704 may support black keys of the piano keyboard. In various embodiments, any given four-bar mechanism may support multiple objects. For example, in some embodiments, four-bar mechanism 704 may support both black keys and a rack, which in turns may support one or more objects (e.g., a tablet computer).

In some embodiments, the angular rotations of four-bar mechanisms 702 and 704 may be 90 degrees for the white keys and 70 degrees for the black keys, respectively. Other degree amounts are possible, depending on the particular embodiment.

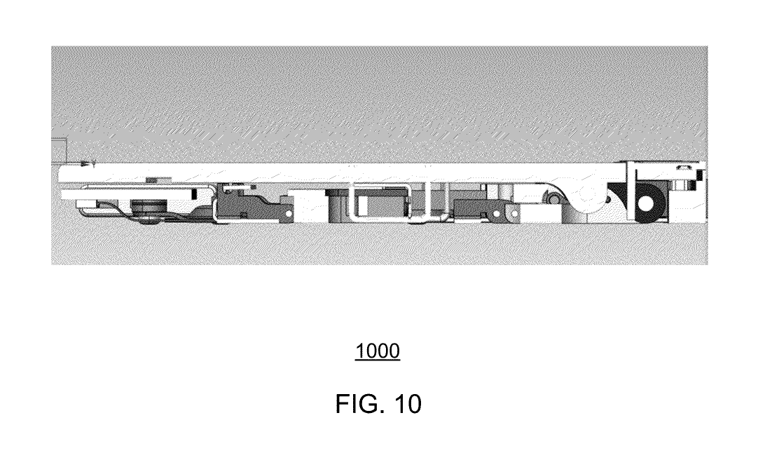

FIG. 10 is a schematic side view showing an example portion of a pop-up assembly 100 implemented as a keyboard apparatus in closed state, according to some embodiments.

As shown, in a closed state, four-bar mechanisms 702 and 704 collapse such that the tops of the white and black keys are align/flush.

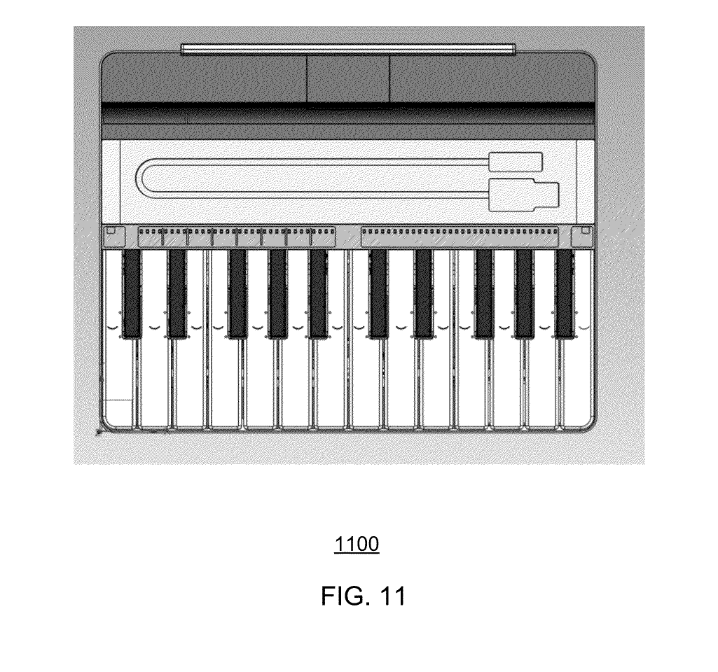

FIG. 11 is a schematic top view of an example pop-up assembly 1100 implemented as a keyboard apparatus in a closed state, according to some embodiments.

In various embodiments, each of the four-bar mechanisms 702 and 704 are configured to support multiple objects. For example, as shown, four-bar mechanism 702 may be configured to support multiple white keys, and four-bar mechanism 704 may be configured to support multiple black keys. Furthermore, four-bar mechanisms 702 and 704 may be configured to stagger the white keys and black keys as shown.

As indicated above, in various embodiments, four-bar mechanism 706 enables four-bar mechanisms 702 and 704 reach the open state at substantially the same time, and reach the closed state at substantially the same time. Furthermore, four-bar mechanisms 702 and 704 are positioned relative to each other such that the rear of the black keys and the rear of the white keys are in line in the open state, in the closed state, and during the transition between the open state and the closed state.

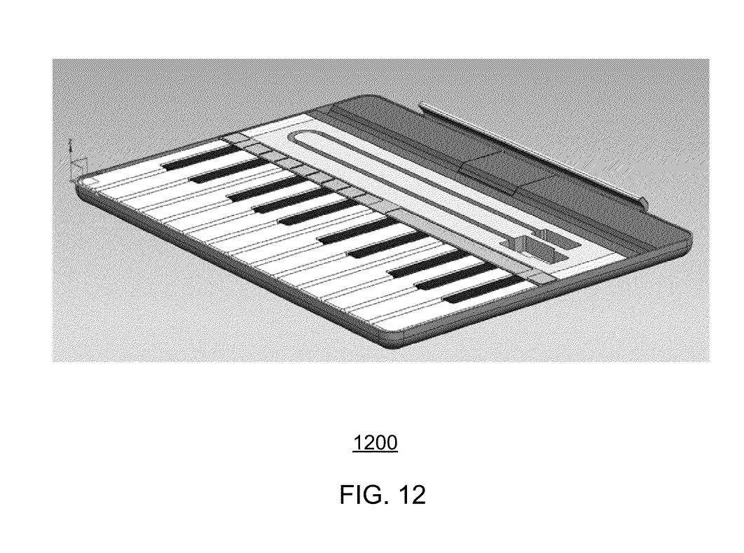

FIG. 12 is a schematic perspective view of an example pop-up assembly 1200 implemented as a keyboard apparatus in an open state, according to some embodiments.

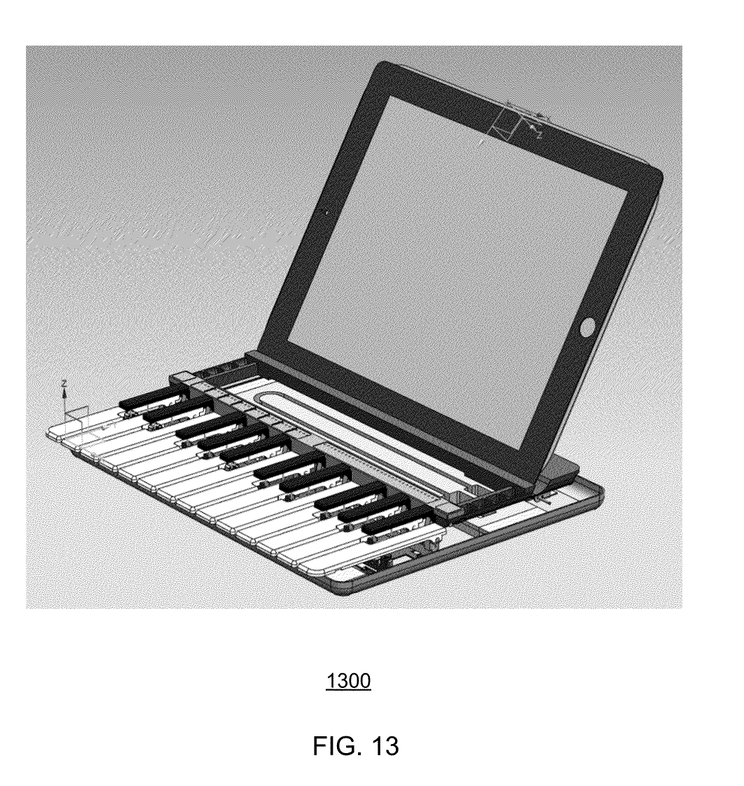

FIG. 13 is a schematic perspective view of an example pop-up assembly 1300 implemented as a keyboard apparatus 700 in an open state, according to some embodiments.

Keyboard apparatus 700 includes a rack, which is supported by a four-bar mechanism such as four-bar mechanism 704 of FIG. 7. The rack is configured to hold a user interface device (e.g., a display device, a computing device such as a tablet computer, etc.).

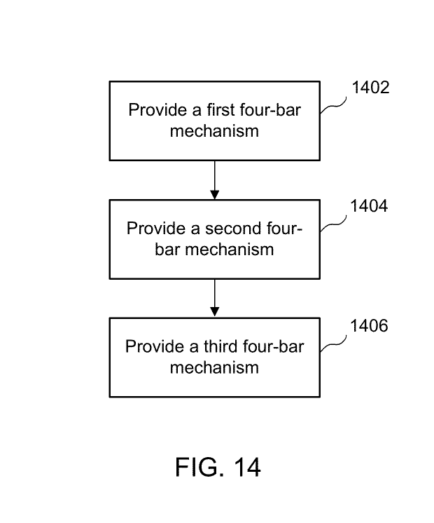

FIG. 14 illustrates an example simplified flow diagram for providing a pop-up apparatus, according to some embodiments. In various implementations, a method is initiated in block 1402 where a first four-bar mechanism 702 is provided. In various embodiments, four-bar mechanism 702 is a four-bar parallelogram linkage. In various embodiments, four-bar mechanism 702 is operably connected to a first user interface, where four-bar mechanism 702 enables the first user interface to be positioned in a first plane.

In block 1404, a second four-bar mechanism 704 is provided. In various embodiments, four-bar mechanism 704 is a four-bar parallelogram linkage. In various embodiments, four-bar mechanism 704 is operably connected to a second user interface, where four-bar mechanism 704 enables the second user interface to be positioned in a second plane.

In block 1406, a third four-bar mechanism 704 is provided. In various embodiments, four-bar mechanism 706 is a convex quadrilateral linkage. In various embodiments, four-bar mechanism 706 is operably connected to the first and second four-bar mechanisms 702 and 706, where four-bar mechanism 706 synchronizes movement of the first and second four-bar mechanisms 702 and 706.

Embodiments described herein provide various benefits. For example, embodiments provides professional and non-professional musicians to create music with more precision. Embodiments provide enhanced responsiveness of the keys of a musical device when the user presses the keys.

Although the description has been described with respect to particular embodiments thereof, these particular embodiments are merely illustrative, and not restrictive. Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments. For example, a tangible medium such as a hardware storage device can be used to store the control logic, which can include executable instructions.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

A “processor” includes any suitable hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems. A computer may be any processor in communication with a memory. The memory may be any suitable processor-readable storage medium, such as random-access memory (RAM), read-only memory (ROM), magnetic or optical disk, or other tangible media suitable for storing instructions for execution by the processor.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A method comprising:
receiving an analog signal from a non-contact sensor of a music device; and
determining a plurality of positions of a key of the music device based on the analog signal.

2. The method of claim 1, wherein the non-contact sensor is a photo sensor.

3. The method of claim 1, wherein the non-contact sensor is an infrared photo sensor.

4. The method of claim 1, wherein the analog signal is based on movement of the key.

5. The method of claim 1, wherein the analog signal is based on continuous movement of key of the music device.

6. The method of claim 1, wherein the determining of the plurality of positions of the key of the music device is based on a scan of the non-contact sensor.

7. The method of claim 1, wherein the determining of the plurality of positions of the key of the music device is based on a scan of the non-contact sensor, wherein the scanning is performed at a predetermined time relative to an emitter sending a signal and the non-contact sensor receiving the signal.

8. A non-transitory computer-readable storage medium carrying one or more sequences of instructions thereon, the instructions when executed by a processor cause the processor to perform operations comprising:
receiving an analog signal from a non-contact sensor of a music device; and
determining a plurality of positions of a key of the music device based on the analog signal.

9. The computer-readable storage medium of claim 8, wherein the non-contact sensor is a photo sensor.

10. The computer-readable storage medium of claim 8, wherein the non-contact sensor is an infrared photo sensor.

11. The computer-readable storage medium of claim 8, wherein the analog signal is based on movement of the key.

12. The computer-readable storage medium of claim 8, wherein the analog signal is based on continuous movement of key of the music device.

13. The computer-readable storage medium of claim 8, wherein the determining of the plurality of positions of the key of the music device is based on a scan of the non-contact sensor.

14. The computer-readable storage medium of claim 8, wherein the determining of the plurality of positions of the key of the music device is based on a scan of the non-contact sensor, wherein the scanning is performed at a predetermined time relative to an emitter sending a signal and the non-contact sensor receiving the signal.

15. A method comprising:
providing a non-contact sensor in a music device, wherein the music device includes at least one key; and
enabling the non-contact sensor to generate an analog signal based on a movement of a key of the music device.

16. The method of claim 15, wherein the non-contact sensor is a photo sensor.

17. The method of claim 15, wherein the non-contact sensor is an infrared photo sensor.

18. The method of claim 15, wherein the analog signal is based on movement of the key.

19. The method of claim 15, wherein the analog signal is based on continuous movement of key of the music device.

20. The method of claim 15, further comprising determining a plurality of positions of the key of the music device based on a scan of the non-contact sensor.
